(19) United States
(12) Patent Application Publication
(10) Pub. No.: US 2019/0114564 A1
(43) Pub. Date: Apr. 18, 2019

(54) Enriched Logistics System for Unmanned Vehicle Delivery of Parcels

(71) Applicant: United Parcel Service of America, Inc., Atlanta, GA (US)

(72) Inventors: Jerome Ferguson, Princeton, NJ (US); Jeffrey Cooper, Atlanta, GA (US)

(21) Appl. No.: 15/787,556

(22) Filed: Oct. 18, 2017

(51) Int. Cl. G06Q 10/04; G06Q 10/08; B64C 39/02

(52) U.S. Cl. CPC G06Q 10/047; G06Q 10/0832; B64C 2201/141; B64C 39/02; B64C 2201/128; G06Q 10/0838

(57) ABSTRACT

Systems, methods, and media are described for enriched logistics decision-making for logistics systems having unmanned systems for use in delivering parcels. In some cases, logistics route plans may be determined based on historical, real-time, and predicted navigation factors or variables, such as weather, traffic, transporter type, etc. Using this information, a set of candidate route plans may be determined. The candidate route plans may be ranked using one or more weighted objectives, such as reducing delivery time and/or cost. Parcel transporters may navigate the highest ranked route plan to transport a parcel. In some aspects, implementation of route plans may be monitored by comparing measured real-time data to the predicted values from the enriched decision-making. In some cases, the implemented route plans may be monitored and adjusted or abandoned based on the monitoring.

### BACKGROUND

Transportation of parcels between locations, such as package pickup or delivery, has evolved over the years due to emerging technologies to solve problems, such as increasing demand for delivery, expanding delivery areas, reducing delivery time and cost, increasing delivery efficiency, and the like. For example, delivery has evolved from delivering a parcel on foot; to using a horse-and-buggy; to delivering a parcel using manned vehicles, such as trains, cars, tractor trailers, and planes.

Conventional logistics systems account for the various types of delivery methods when determining a route from a pickup location to a delivery location. For example, a parcel may be picked up by a driver at the pickup location. The driver may take the parcel to a sorting facility where it is loaded on a tractor trailer or an aircraft and delivered to another sorting facility. The parcel may then be picked up by another driver and delivered to the final delivery location. Conventional logistics systems may determine the route based on these types of delivery methods.

To meet the increasing demand for delivery and to increase parcel transport efficiency, some have begun to experiment with unmanned aerial vehicles (UAVs) to transport parcels. UAVs have the potential to revolutionize parcel transportation because they are not constrained to the inherent restrictions of conventional delivery methods. For example, manned delivery vehicles must use common roadways, which may be subject to construction or heavy traffic, and may not provide the most direct route to a delivery location. Manned delivery aircraft are limited as to where they can take off and land; they are costly, and they typically must carry large volumes to be economically viable. To the contrary, UAVs offer the promise of small volume, commercially viable delivery.

However, logistics problems have emerged when attempting to deliver parcels using UAVs and when integrating UAVs into current logistics technologies that were designed under different constraints. For instance, conventional logistics systems are not capable of accounting for emerging unmanned parcel transportation systems and processes when generating and optimizing routes, and making near-real time route modification or transportation decisions. Simply, the conventional logistics systems lack the capacity to account for the many factors that affect unmanned parcel transportation technology. For example, conventional vehicles are restricted to a set of predefined navigation routes, i.e., roadways. UAVs do not have these types of restrictions; however, they have a multitude of other constraints, such as weather and federal regulations or pre-determined virtual highways enabled for UAV traffic. Compounding the problem, optimized parcel transportation processes may utilize multiple and contingent route plans that not only comprise segments traversed by manned terrestrial vehicles, but may also comprise segments traversed by unmanned and/or UAV systems. In such cases, conventional logistics systems fail or are ill-equipped to handle efficient, predictable transportation. For example, conventional approaches apply a stagnant set of rules based on non-analogous delivery methods to make delivery decisions, such as logistics rules that do not account for historical delivery patterns, and are limited to manned delivery methods and/or terrestrial delivery methods. Further, conventional logistics systems have not been developed to account for these new types of delivery arrangements, which may include coordinating multiple routes, accounting for real-time changes and contingencies, and demand a more enriched data input necessary for more complex automated computer decision-making and optimization.

### SUMMARY

The present technology generally relates to systems, methods, and media for optimizing logistics decisions based on machine learning through artificial intelligence and other advanced programming techniques when options are available for delivering a parcel using an unmanned system. More particularly, aspects of the present technology relate to enriched logistics decision-making for delivery/pickup of parcels, which in some cases will include UAVs.

Embodiments of the disclosure described herein provide technologies for optimizing parcel transporter route determinations utilizing various transporter delivery technologies, such as transporting parcels utilizing UAVs. For example, information necessary to optimize parcel transporter routes may be determined by sensors associated with the external environment, with the parcel transporters, with the parcel, and the like. Similarly, historical information and information from other data sources may also be retrieved. Some non-limiting examples of the types of information that may enrich logistics decision-making include power source availability or capacity of a transporter; range of a transporter; size and weight of a transporter; available payload and capacity; maximum payload and capacity; transporter type: manned or unmanned, and aquatic, aerial, or terrestrial; location of transporters; regulatory guidelines; weather patterns and conditions; road and traffic conditions; air traffic; changed or new delivery/pickup requests; dimensions, weight, and service level of parcel; special parcel instructions, such as a signature requirement or handling fragile, perishable, or volatile contents; shipper preferences; recipient preferences; and so forth.

Using this information, a set of candidate route plans may be determined. These route plans may be ranked according to one or more weighted objectives, which may be particular to a single parcel or across multiple parcels, such as shortest delivery time, lowest cost delivery, lowest fuel usage or energy consumption, least number of parcel transfers between vehicles or parcel transporters, or other preferences or objectives. A route plan may be selected or otherwise determined from the ranked set and implemented or communicated through a network to one or more parcel transporters for implementation. In some embodiments, aspects of an implemented route plan, such as predicted information included in the route plan, may be compared against real-time feedback information in order to monitor the implementation of the route plan, and modify the route plan, select an alternative route plan from the ranked set, and/or initiate failsafe procedures if needed.

Additional objects, advantages, and novel features of the technology will be set forth in part in the description which follows, and in part will become apparent to those skilled in the art upon examination of the following or learned by practice of the technology.

### BRIEF DESCRIPTION OF THE DRAWINGS

The present technology is described in detail below with reference to the attached drawing figures, wherein:

FIG. 1 is an exemplary operating environment suitable for implementing aspects of the present technology;

FIG. 2 is a block diagram depicting an exemplary computing architecture suitable for implementing aspects of the present technology;

FIGS. 3-5 are flow diagrams that show exemplary methods for determining a route plan based on enriched data, in accordance with the technology described herein; and

FIG. 6 is a block diagram of an exemplary computing environment suitable for use in implementing an embodiment of the present technology.

### DETAILED DESCRIPTION

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” and/or “block” might be used herein to connote different elements of methods employed, the terms should not be interpreted as implying any particular order among or between various steps herein disclosed unless and except when the order of individual steps is explicitly stated.

Aspects of the present technology relate to enriched logistics decision-making for transportation of parcels, which may include the delivery/pickup of parcels, and which in some cases will include unmanned parcel transporters, such as UAVs. One or more sensors may be utilized to provide sensor data to a logistics system. For example, sensors may be associated with parcel transporters or systems, such as manned vehicles and unmanned vehicles. These sensors, for example, may determine energy level (e.g., remaining power supply of a parcel transporter), payload, capacity, location, and so forth. In some instances, sensors may be associated with parcels, for example, to detect the location of the parcel. Other sensors may be associated with the environment, for example, to determine traffic patterns and weather conditions. These are but a few examples of sensors and types of data that may be used to help make enriched logistics decisions.

In some cases, information utilized for embodiments of logistics systems described herein may be further determined from other customers, third parties, or regulations. For example, regulatory conditions, temporary or permanent no-fly zones, weather information, and requests for new deliveries or pickups or changes to deliveries or pickups. In some aspects, historical information may be retrieved. For example, historical information such as maintenance needs of a particular transporter or category of transporter, size and weight of a transporter, payload and carrying capacity for a transporter, a history of routes navigated by a transporter and collected data pertaining to the routes, locations of transporters, and so on. Historical information may also include customer-based (including shipper-based and recipient-based preferences) delivery/pickup preferences, such as release/pickup zones, customer-requested no-fly zones, customer-requested transporter types, customer-requested delivery times, carrier-determined customer patterns, shipper preferences, and the like. All of these examples, and others described herein, may be used in making enriched logistics decisions.

Based on this information, aspects of the logistics system technology described herein may determine route plans, which consist of one or more routes by individual parcel transporters to transport a parcel from one location to another. For example, a parcel transporter or a plurality of transporters may transport a parcel from a beginning parcel location to an ending parcel location to facilitate delivery, pick up, or transport of a parcel. In some cases where there is a plurality of routes, a hand-off of the parcel may be made between transporters associated with the different routes. Some route plans may include UAVs over all or portions of the route plan. In some aspects, a set of candidate route plans is generated based on available parcel transporters. In some cases, using the enriched data, a set of corresponding ranges and potential routes for a transporter may be determined for the available parcel transporters. For example, it may be determined that a UAV flying against the wind will have less range than a UAV flying in the same direction as the wind. From the sets of potential routes, a set of candidate route plans may be assembled by connecting one or more of the potential routes for a particular parcel transporter, with a route plan starting at a beginning parcel location and terminating at an ending parcel location. In some embodiments, multiple, and in some instances, overlapping and/or mutually exclusive route plans may be determined in the set. The set of determined candidate route plans then may be ranked according to weighted objectives, such as minimizing transportation times or minimizing transportation costs. Based on the ranking, a particular route plan having the highest ranking may be determined and implemented by the logistics system. In some embodiments, the determined route plan may be communicated, in whole or in part, to one or more transporters associated with the route plan, such as the particular transporters that are intended to be traversing the route plan.

In some cases, a route plan may include forecasted or predicted information, such as future locations of transporters at particular times. In some embodiments, as a route plan is implemented, the predicted information may be compared to real-time information (which may include near-real time information) regarding the route plan. Such real-time information may be provided by the one or more sensors, for example. By comparing this information, the route plan implementation may be monitored for errors or unpredicted events. In some embodiments, based on information received while monitoring the route plan, the logistics system may determine that an implemented route plan needs to be modified. For example, in some embodiments, where the real-time data indicates that a particular transporter will be unable to perform its planned route within a corresponding time frame, that may be specified in the route plan or determined from the route plan, then it may be determined that the implemented route plan is no longer feasible and should be abandoned or modified. In some cases, it may be determined that a route plan should be abandoned or modified based on newly received information from the carrier or a customer. For instance, a new delivery/pickup request may be received. Based on determining that the route plan needs to be modified or abandoned, a new route plan or adjusted route plan may be implemented. In some cases, the new route plan or adjusted route plan may be implemented by determining a set of candidate route plans, ranking the set of candidate route plans based on one or more weighed objectives, determining the highest ranked route plans, and implementing the highest ranked route plan as a new or adjusted route plan. In some embodiments, one or more implemented route plans may be continuously monitored and adjusted by embodiments presented herein. In some cases, new locations may result from implemented failsafe procedures, such as landing a UAV in a safe area or ceasing navigation by a transporter (further described below). These new locations may additionally be included when determining a new or adjusted route plan.

In some emergency cases, such as mechanical damage to a parcel transporter or unexpected weather conditions, failsafe procedures may be utilized. For instance, in some cases, failsafe procedures for unmanned vehicles may include: returning to a building or location that is associated with the carrier; sending a notification to a carrier that failsafe procedures have been initiated, which may include a location of the transporter that initiated failsafe procedures; giving control over to a human operator, which may include remote human operators; ceasing navigation; or the like. In cases where UAVs are utilized as parcel transporters, failsafe procedures may also include landing the UAV in the nearest or predetermined area and/or initiating obstacle avoidance to avoid collisions with, for example, structures, people, or animals.

Some embodiments of the logistics technologies described herein may utilize machine learning and other aspects of artificial intelligence to facilitate the inclusion of a wider range of logistics variables and other enriched data in the computer-performed decision making and transportation optimization. For instance, transportation logistics including routes and route plans may be continually optimized, based on predicted and real-time data (which may include availability, routes, and ranges of unmanned transporters), throughout the transportation of a parcel, thereby increasing delivery efficiency and maximizing delivery resources to help meet the increasing delivery demand.

In this way, embodiments described herein solve the problems created by the conventional systems, including an inability to account for unmanned delivery methods when determining logistics routes. The embodiments described herein account for the enriched data that allow for route optimization where unmanned systems may be used to transport parcels. The enriched data, for example, regulatory and consumer-defined no-fly zones, weather data, infrastructure data, which may include historical, real-time, and predicted data, and the like, allow for greater route optimization than conventional systems were capable of determining. In some cases, the embodiments described herein enable optimizing logistics systems that utilize unmanned systems, which are not limited to the navigational constraints that conventional logistics systems were designed under. As such, embodiments described herein enable logistics systems that can optimize route generation when both manned and unmanned, terrestrial and aerial, transporters are utilized to transport a parcel from a beginning location to an ending location, enabling route optimization beyond that of the stagnant rules and non-analogous delivery methods that restrict conventional logistics systems from making these determinations.

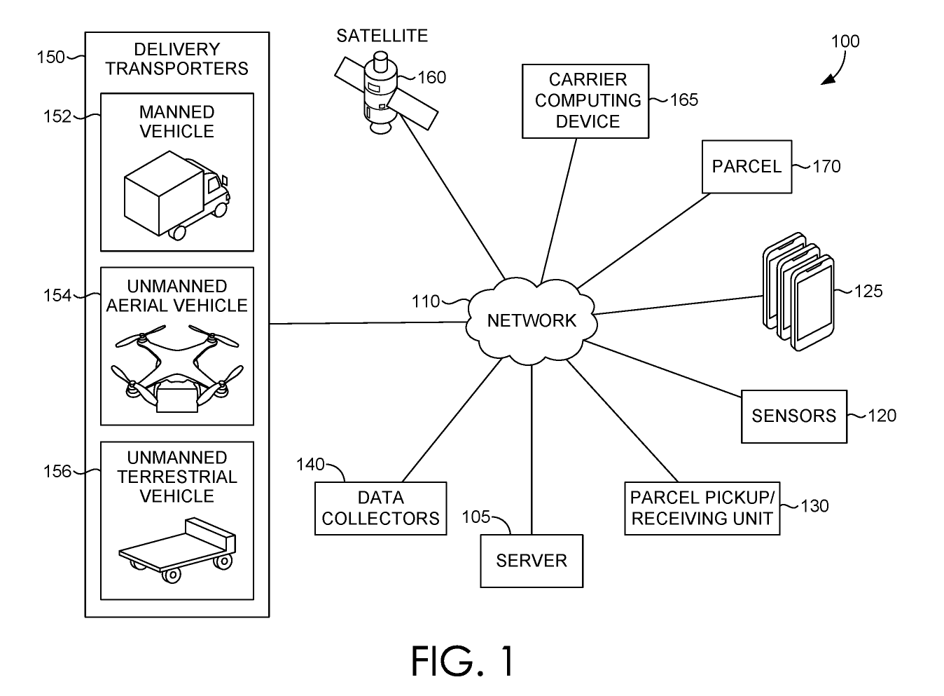

Having described an overview of exemplary aspects of the present technology, an exemplary operating environment 100 in which aspects of the technology described herein may be implemented is provided by FIG. 1 and further described below in order to provide an example of a general context of the technology. Referring now to FIG. 1, example operating environment 100 is provided. Example operating environment 100 is but one example of the type of operating environment in which aspects of the present technology may be practiced. It is not intended to suggest any limitations as to the scope or functionality of operating environment 100 or its components. Similarly, operating environment 100 should not be interpreted as requiring or prohibiting certain components. Instead, a person of ordinary skill would understand that embodiments of the technologies described herein may be practiced in an operating environment with more or less components than those depicted in FIG. 1.

Further, the depictions of the various components of operating environment 100 in FIG. 1 are not intended to define the structural relationship or arrangement among the various components. Put another way, many of the components are functional entities that may be implemented as discrete or distributed components or in conjunction with other components, and in any suitable combination and location. For example, sensors 120 may be positioned on personal computing device 125, on parcel pickup/receiving unit 130, on parcel transporters 150, and so forth. Instead, the various components are illustrated separately to more easily describe the technology, and other arrangements are contemplated within the scope of this description. Moreover, the various functions described as being performed by one or more of the components may be carried out by hardware, firmware, software, or any combination of each. For instance, some functions may be carried out by a processor executing instructions stored in memory.

With continued reference to FIG. 1, exemplary operating environment 100 depicts server 105, sensors 120, personal computing device 125, parcel pickup/receiving unit 130, data collectors 140, parcel transporters 150, satellite 160, carrier computing device 165, and parcel 170. As illustrated in FIG. 1, these components may communicate with each other via network 110, which may include, without limitation, one or more local area networks (LANs) and/or wide area networks (WANs). In exemplary implementations, network 110 comprises the Internet and/or a cellular network, or any of a variety of possible public and/or private networks.

Many of the components of operating environment 100, such as personal computing device 125 and carrier computing device 165, can be user devices on the user side or client side of operating environment 100, while server 105 may operate on a backend or in some instances a server side of operating environment 100. Such user-side components may facilitate the completion of tasks and make a record of activities, such as scanning parcels at particular locations and times, requesting delivery/pickup of a parcel, determining the location of a user, and so on. Server 105 may comprise distributed software operating across user- and server-side, or server-side software designed to work in conjunction with user-side software on user-side devices, so as to implement any combination of the features and functionalities of the present technology. This division of operating environment 100 is illustrated to be one example of a suitable environment, and there is no requirement for each implementation that any combination of server 105 and user-side devices exist as separate entities.

Sensors 120 may comprise any component capable of obtaining data including a component that derives or determines data from other data. For example, sensors 120 may collect raw data, such as temperature, humidity or location; or may collect and combine or process data to determine information, for example, speed of a vehicle, i.e., the change in its location over a particular time. Data from sensors 120 may be stored to determine historical patterns. For example, along certain routes, the average speed of parcel transporters 150 may be greater at some times than at others. Although example operating environment 100 shows sensors 120 as a separate component, it is contemplated that in some embodiments, sensors 120 are on or associated with other components of environment 100. In some embodiments, sensors 120 may be located at any part of a logistics chain. For example, sensors 120 may be associated with the parcel to determine its location, environmental conditions experienced by the parcel, and/or forces exerted on the parcel during shipment. Sensors 120 may be associated with parcel pickup/receiving unit 130, with parcel transporters 150, with carrier computing device 165, and so forth. Sensors may collect or otherwise receive data directly, such as a thermometer would collect local temperature; they may collect information remotely, such as a video from a remote camera being stored and viewed at another location; or they may collect information in conjunction with other sensors 120 or systems, such as location information that is derived using a sensor communicating with the Global Positioning System (GPS).

Personal computing device 125 may comprise any type of computing device capable of use by a user and/or suitable for collecting information from the user. By way of example and not limitation, personal computing device 125 may be embodied as a personal computer (PC), a laptop computer, a mobile device, a smartphone, a tablet computer, a smart watch, a wearable computer, a fitness tracker, a virtual reality headset, augmented reality glasses, a personal digital assistant (PDA), an MP3 player, a global positioning system (GPS) or device, a digital camera, a video player, a handheld communications device, a gaming device or system, an entertainment system, a vehicle computer system, an embedded system controller, a remote control, an appliance, a consumer electronic device, a workstation, or any combination of these delineated devices, whether integrated or distributed, or any other suitable device. In some cases, personal computing device 125 may include devices such as smart mailboxes; smart home appliances; such as a smart refrigerator; smart thermostat; personal assistant, such as Amazon Echo or Google Home; or other smart systems that are capable of providing information to a user and collecting information from a user. In some cases, the user may interact with personal computing device 125 by running apps, such as computer software applications stored locally or accessed from a distributed datastore. In some cases, apps may access information about the user through other apps or services operating on the personal computing device 125 or operating in the cloud and associated with personal computing device 125. For example, in some embodiments a user may provide permission for a user-side logistics app to access other apps that the user may utilize, such as a calendar app, a contacts app, a location app or service, a communications app or service such as email or instant messaging, which may include accessing a user's email account with permission, a gaming app, a microphone app, and so on, in order to access and receive information about the user. In this way, additional information about a user may be received by accessing apps and services on one or more personal computing devices 125 utilized by the user.

Parcel pickup/receiving unit 130 may comprise a container, receptacle, locker, zone, building, or similar area where a parcel 170 may be received, delivered, and/or unloaded or loaded onto parcel transporters 150, and may include any location where a customer would go to drop off or pick up a parcel. For example, parcel pickup/receiving unit 130 may include a brick-and-mortar store or a large distribution center; it may include parcel drop boxes or lockers; it may include another parcel transporter, for example parcel 170 may be loaded onto unmanned aerial vehicle (UAV) 154 from manned vehicle 152; and so on. In each of these cases, parcel 170 may be loaded onto parcel transporters 150 by an autonomous mechanism or manually by a human. In some cases, parcel pickup/receiving unit 130 may collect information about parcel 170. For example, it may determine the dimensions, weight, and contents of parcel 170. Such information may be utilized to determine types of delivery methods, and delivery routes/plans. In some cases, this information may be determined by a person, such as an employee of a store that is used for sending and receiving parcels, or may be automatically determined, for example, by a smart dropbox that determines the presence of parcel 170, how much it weighs, and its dimensions. In some cases, such as based on the contents of parcel 170 or based on a request by an interested party, parcel pickup/receiving unit 130 may determine or receive a service level for parcel 170. For example, the service level may be based on shipping parcel 170 at the lowest cost; over the shortest shipping time; over a designated shipping time; using certain customer requests, such as a request for specialized care or a request that the parcel not be delivered by a UAV; or any other factor. In some cases, the service level may be designated or described as Same Day Service, Next Day Air, Next Day Air Early AM, Next Day Air Saver, 2nd Day Air, 2nd Day Air Early AM, 3 Day Select, Ground, or another designation.

In some cases, parcel pickup/receiving unit 130 may determine information about the sender or the recipient. For example, parcel pickup/receiving unit 130 may determine that a particular sender is sending a parcel at a particular time. For instance, in an embodiment, parcel pickup/receiving unit 130 may include a sensor to read data from a parcel, such as an identifier, tracking number, code, or the like. In some embodiments, parcel pickup/receiving unit 130 may receive information—via network 110 from server 105 and/or a user-side logistics app operating on a personal computing device 125—which includes information about the sender or recipient. This information may be saved and combined with historical information to draw inferences or make predictions about particular users, for example, that a particular user sends parcels on the same day each week; that the user is a common shipper; that the user routinely sends parcels having a similar size, shape, and weight; that the user sends to different recipients each time; and so forth.

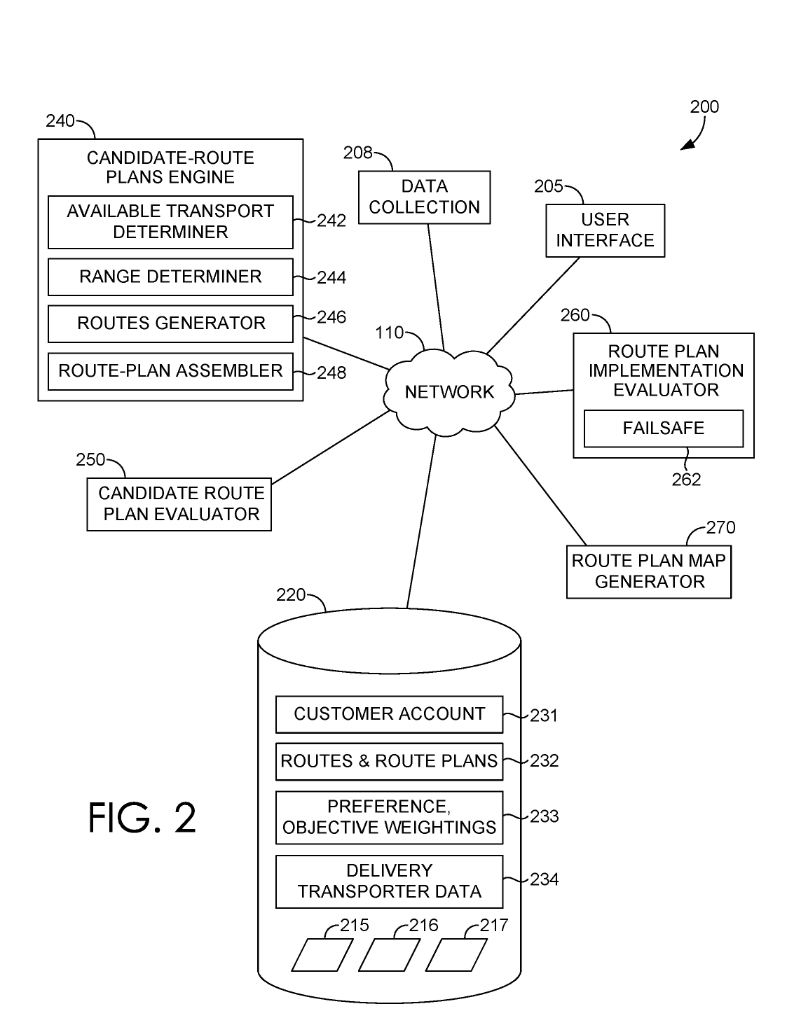

Data collectors 140 may comprise component(s) that derive or determine navigation data from one or more data sources. In some embodiments, data collectors 140 may receive and in some instances determine data, including data from third-party services. For example, weather data may be received from national or local weather sources or determined using sensors 120; likewise, traffic information, for example, traffic cameras or construction information; flight regulations, such as no-fly zones; air traffic information; other carrier information; pickup/delivery requests; emergency data; satellite or aerial imagery, such as topographical information; power infrastructure information, such as maps of power lines; information provided by smart-roads, and so forth may be received or determined from data collectors 140. In some embodiments, data collectors 140 may store the received navigation data in storage 220, described in connection with FIG. 2.

Parcel transporters 150 may be any suitable person, vehicle, vessel, or the like that has the ability to transport parcel 170 from one location to another. The examples illustrated in FIG. 1 include manned vehicle 152, UAV 154, and unmanned terrestrial vehicle 156. Other parcel transporters not illustrated in FIG. 1 are contemplated within the scope of this description and may be utilized with aspects of the technology described herein. For example manned aircraft, such as planes; watercraft, such as manned or unmanned boats; subterranean delivery systems; conveyor systems; and the like are contemplated within the scope of possible parcel transporters 150. In some embodiments, a parcel transporter 150 may comprise a human, such as a delivery courier walking from one location to another location with parcel 170. As such, parcel transporters 150 should be interpreted in the broadest reasonable, applicable sense, unless a particular transportation technology is expressly excluded.

In general, unmanned vehicles, such as UAV 154 and unmanned terrestrial vehicle 156, comprise machines that are capable of operating, at least in part, without an on-board human pilot in control. Unmanned vehicles may include terrestrial, aquatic, subterranean, or aerial vehicles. In some instances, unmanned vehicles may have a human on board. The on-board human may be capable of taking control of the unmanned vehicle as desired or needed. In some cases, an unmanned vehicle may be controlled remotely by a human pilot, for example, from a control center. Thus, to complete an objective, unmanned vehicles may operate autonomously, under the guidance of preprogrammed or learned instructions, or under partial or total control of a remote human operator.

Parcel transporters 150 may include or be associated with one or more sensors 120 for collecting navigation data. For example, parcel transporters 150 may utilize positioning systems, such as those that work by cell-tower triangulation or satellite, for determining location, direction, speed, and the like. In some cases, such as those in which UAVs or manned aircraft are utilized, positioning systems may determine other factors associated with flight, such as altitude, pitch, roll, and the like. In some embodiments, these factors may be determined by sensors such as altimeters, barometers, inclinometers, gyroscopes, GPS, or other similar types of sensors.

Parcel transporters 150 may comprise sensors to detect weather conditions, such as anemometers, thermometers, barometers, hygrometers, and the like. Parcel transporters 150 may include sensors to measure power consumption. For example, some sensors 120 may determine a remaining amount of fuel or a remaining level of battery-provided energy in a power source. Similarly, such sensors 120 may further determine a rate of energy or fuel use. In some cases, the sensors may measure amount of energy used or generated. For example, an electric vehicle may use energy by navigating a route to transport a parcel, it may receive energy when it is charging, and in some cases, it may generate energy using photovoltaic cells or other technologies such as regenerative braking. In some cases, each of these may be measured by sensors 120. In some cases, the historical consumption and intake of energy may be stored for particular vehicles and associated with other data derived from other sensors. For example, a historical energy consumption or rate of energy use for a UAV may be associated with wind speed and direction as measured by other sensors, and aggregated data may be used to determine average energy consumption rates for a variety of wind or weather conditions. This is but one example of how data measured from one sensor may be associated with data from another sensor to derive usable information. It is contemplated within the scope of this description that data received by any of the sensors 120 or data collectors 140 may be associated with other forms of data collected from other sensors or data collectors, and may be utilized to interpret or extrapolate various aspects of navigation data.

In some cases, parcel transporters 150 may be equipped with sensors capable of producing images, such as photographs or video, while the parcel transporters 150 are engaged in their normal course of use. These sensors may be CCD-based cameras or other image capturing devices configured to capture images and/or videos.

In some cases, parcel transporters 150 may include sensors 120 to determine payload and capacity, or available payload and capacity for a parcel transporter. For example, manned vehicle 152 may be equipped with a sensor to determine how much volume is available on manned vehicle 152 to receive parcels, e.g., how much space remaining in the vehicle may be utilized for carrying parcels. In some cases, these sensors may measure the weight of the current payload and determine the remaining available payload to transport parcels using parcel transporter 150. In some cases, the data may be combined to determine the remaining payload and capacity. For example, manned vehicle 152 may have empty volume with which it may carry more parcels; however, the collective weight of the parcels being transported by manned vehicle 152 may be at a maximum payload capacity for manned vehicle 152. As such, in this instance, manned vehicle 152 may not be available for receiving another parcel until it has delivered at least a portion of the parcels it is transporting. In another example, UAV 154 may have a certain payload or carrying capacity. A sensor may determine that the parcels being transported by UAV 154 do not exceed the maximum weight for UAV 154 and that there is additional volume available to load an additional parcel. Thus, UAV 154 may be available to receive another parcel before delivery of parcels that it is currently transporting.

Like other data obtained using sensors 120, data collected about the available or utilized weight or volume of parcel transporters 150 may be associated with other data, such as energy consumption. For example, parcel transporters 150 may have various energy consumption rates for particular capacities and payloads. Put another way, parcel transporters 150 may experience lower rates of energy consumption when transporting lower payload weights of parcels.

Turning briefly to FIG. 2, information about parcel transporters 150 described hereinabove may be stored, for example in storage 220, as delivery transporter data 234. For example, this may include information on the types of available parcel transporters 150, e.g., unmanned or manned, aerial, terrestrial, or aquatic. Similarly, this may include information on the size of parcel transporter 150, the carrying capacity or payload, the historical maintenance and future maintenance requirements of parcel transporters 150. Parcel transporter data 234 may also include the average energy consumption of a transporter, which may also be associated with average energy consumption during various weather conditions, such as wind or precipitation, or may include the average power consumption as it relates to the payload of parcels loaded onto the transporter, and the like. These are but a few examples of parcel transporter data 234, and all data collected about or from transporters 150 may be stored as parcel transporter data 234 to be utilized by other logistics components, such as those in FIG. 1 and FIG. 2, to enrich logistics decision-making and route determination in accordance with embodiments described herein.

Turning back to FIG. 1, satellite 160 may facilitate communication along network 110 and may collect and provide information about routes or areas. In some cases, satellite 160 may provide location information to parcel transporters 150, for example, by utilizing GPS. Although environment 100 includes a “satellite,” in some embodiments an aerial vehicle such as a drone or balloon may provide functionality similar to the functionality of satellite 160. In some embodiments, satellite 160 may collect and communicate location information about parcel transporters 150, such as current location and/or trajectory information. In some cases, satellite 160 may provide real-time traffic information, such as how congested roadways are or the location of other aerial vehicles in a particular area. In some cases, satellite 160 may collect and provide weather information, such as the presence of rain or snow. In some cases, satellite 160 may collect and provide other terrestrial information, such as topography or the presence of ground obstacles (e.g., flooded roadways, fallen trees, or other hazards that may impact movement of a parcel transporter 150). This information may be stored to determine historical patterns and/or may be utilized to evaluate an implemented route plan, as further described herein.

Carrier computing device 165 may be a hand-held device carried by a delivery service provider. Carrier computing device 165 may be capable of collecting or determining aspects of logistics information and communicating the information to other components of operating environment 100. Logistics information, as used herein, is information associated with a parcel and the transportation of that parcel. For example, for a parcel received at a sorting facility, logistics information may include an indication that the parcel was received and dispatched at the sorting facility at a particular time, and may include notes associated with the parcel input by an employee of the delivery service provider. As another example, logistics information about the parcel may include the name and address of the shipper and consignee, and the weight and dimensions of the parcel. In some cases, carrier computing device 165 may scan or read machine readable images, for example, one-dimensional and two-dimensional bar codes, such as tracking identifiers printed on parcels. In some cases, carrier computing device 165 may generate and/or print a label or tag having indicia identifying a tracking number and/or other logistics information. In some cases, carrier computing device 165 may write to or receive information from machine readable tags, such as radio-frequency identification (RFID) tags and labels having coded indicia in the form or a barcode and/or QR code. For instance, parcel 170 may have a bar code or a machine readable tag attached to it. The bar code or tag may have associated identification information that may be interpreted by carrier computing device 165. In this way, carrier computing device 165 may receive information about parcel 170, such as navigation data that may be entered into carrier computing device 165 and stored in association with parcel 170. In some cases, carrier computing device 165 may further communicate or receive information to a user through audible or visual technology. Carrier computing device 165 may send and receive logistics information about parcel 170, such as when and where parcel 170 is picked up, where parcel 170 is located at a given time along a logistics route, and when and where parcel 170 is delivered. In some cases, carrier computing device 165 may be associated with a carrier in the business of receiving and delivering parcels from pickup locations to delivery locations.

In some cases, carrier computing device 165 may have any number of associated sensors 120 for collecting information. For example carrier computing device 165 may be equipped with a camera for capturing images; a microphone for capturing audio information; GPS and accelerometric sensors for acquiring information about the local delivery/pick-up environment, which may indicate information about the local topography and local paths, such as the local path a courier traverses from a transporter truck to the front door of a parcel recipient's home; and the like.

In some embodiments, carrier computing device 165 may determine its location through a positioning system, such as a GPS or by using cell-tower triangulation. In some cases, carrier computing device 165 may record and transmit this information to other components of operating environment 100 or components described in connection with FIG. 2. In one example, carrier computing device 165 may be associated with a user, such as an employee of the carrier. Carrier computing device 165 may collect information associated with routes taken by the user, such as while driving, while walking, or a combination, such as driving to a delivery/pickup location and walking a path from the street to the entrance of the delivery/pickup location, for instance, using the positioning and accelerometric sensors. In some cases, carrier computing device 165 may collect other information, such as whether the user went up or down in elevation or encountered some form of obstacle, such as having to open a gate. In some cases, carrier computing device 165 may determine the speed at which the user is traveling along a route, or the average time to complete the route. This data may be stored for future use or may be utilized as real-time navigation data. In one example, carrier computing device 165 may detect that it is traveling along a previously used delivery route, e.g., the location and the route match historical information previously gathered and stored. In some cases, it may determine that the user is lagging behind or is ahead of the average time that the route was completed in the past.

In some cases, carrier computing device 165 may collect information about the timing of events. For example, carrier computing device 165 may determine that parcel 170 was picked up or delivered at a particular time. It may further determine that, historically, at certain times, the user is making a delivery to a particular location. In some instances, it may determine the amount of time a particular route takes and store this information as historical data. In some cases, it may determine time where deliveries were unsuccessful. For example, if the carrier attempted to deliver a parcel to a location at a particular time and no one was available to receive the parcel, then carrier computing device 165 may store the information associated with the particular time. In some cases, this information may be extrapolated to predict that at particular times, a successful delivery is less likely than at other times.

Turning to FIG. 2, a block diagram is provided showing aspects of an example computing system architecture suitable for implementing embodiments of the technology, and designated generally as system 200. System 200 is only one example of a suitable computing system architecture. Other arrangements and elements can be used in addition to or instead of those shown. Some elements may be omitted altogether for the sake of clarity. Further, as with operating environment 100, many of the elements described herein are functional entities that may be implemented as discrete or distributed components or in conjunction with other components, and in any suitable combination and location.

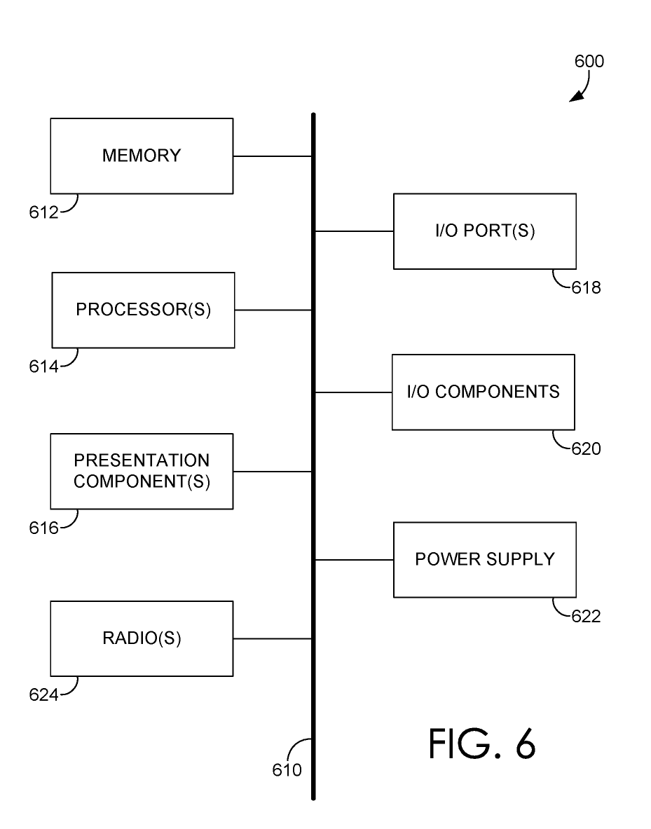

With reference to FIG. 2 and continuing reference to FIG. 1, system 200 includes network 110, which is described in connection to FIG. 1, and which communicatively couples components of system 200 including a user interface 205, data collection 208, datastore or storage 220, candidate-route plans engine 240 (having subcomponents: available transport determiner 242, range determiner 244, routes generator 246, and route plan assembler 248), candidate route plan evaluator 250, route plan implementation evaluator 260 (having subcomponent: failsafe 262), and route plan map generator 270. In some cases, these components may be embodied as a set of compiled computer instructions or functions, program modules, computer software services, or an arrangement of processes carried out on one or more computer system, such as computing device 600 described in FIG. 6, for example.

In one embodiment, functions performed by some of the components of system 200 are associated with one or more virtual assistant applications, services, or routines. For example, such applications, services, or routines may operate on one or more user devices (for example, personal computing device 125 and carrier computing device 165) and servers (for example, server 105), and may be distributed across one or more user devices and servers, or be implemented in the cloud. Moreover, in some embodiments, the components of system 200 may be distributed across a network (for example, network 110), including one or more servers and client or user devices, in the cloud, or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments described herein can be performed, at least in part, by one or more hardware logic components (for example, logic 215, 216, and 217). For example, and without limitation, illustrative types of hardware logic components that can be used include Field-programmable Gate Arrays (FPGAs), Application-specific Integrated Circuits (ASIC s), Application-specific Standard Products (ASSPs), System-on-a-chip systems (SOCs), Complex Programmable Logic Devices (CPLDs), etc. Additionally, although functionality is described with regard to specific components shown in system 200, it is contemplated that, in some embodiments, functionality of these components can be shared or distributed across other components.

With continued reference to FIG. 1 and FIG. 2, user interface 205, in the broadest sense, may be any mechanism that conveys information to a user, and in many cases, may accept inputs of information from the user. In general, user interface 205 may be a graphical user interface for visually conveying information, and in some cases, may be touch sensitive to receive inputs from the user.

Data collection 208 is generally responsible for accessing or receiving data from one or more of any of the sources of data, such as any of sensors 120 and/or data collectors 140 of FIG.1, or from storage 220 of FIG.2. For example, any data collected or gathered by the components of FIG. 1 or sensors thereof may be accessed or received by data collection 208. In some cases, the data may be collected, accumulated, reformatted, and/or combined with other forms of data and stored, for example, in storage 220. In some cases, data may be received at data collection 208 by way of data streams or signals. A “data signal” may be a feed or stream of data from the corresponding data source. For example, a user signal could be from a smartphone, a home-sensor device, a location determining device (such as one utilizing GPS), a sensor associated with parcel transporter 150, a wearable device, personal computing device 125, carrier computing device 165, or other sensors 120 or data collectors 140. Similarly, the data stream or data signal may be received from a calendar service, an email account, a credit card account, or other data sources, such as those that may be accessed via apps. In some embodiments, data collection 208 receives or accesses data continuously, periodically, or as needed.

As used herein, the term navigation data is defined broadly to include any data or information that may be utilized by embodiments of logistics systems described herein, such as data used to facilitate transport of a parcel and other data discussed in connection with FIG. 1 or FIG. 2, e.g., data received by data collection 208 from any of the components of FIG. 1 and data stored in storage 220, discussed below. Navigation data may include, by way of example and without limitation, weather/atmospheric data, such as precipitation and wind information, for instance; traffic data; customer information data, such as customer preferences and restrictions; regulatory information, such as no-fly zones; crowd-sourced information, which may include information derived from personal computing devices 125 or other users; other types of sensor data, historical navigation data, real-time data, predicted or forecasted data, and the like. In some cases, crowd-sourced data may be received by data collection 208. For example, information may be received from a plurality of personal computing devices 125 described in FIG. 1, such as other users of a logistics app. Collectively, this information may be interpreted and used to determine navigation data; for instance, it may be used to determine potential no-fly zones for a UAV 154. For example, a large number of personal computing devices 125 in or near the same location may indicate a gathering, such as sporting event or another temporary crowd, which may further indicate a temporary no-fly zone. Other crowd-sourced information may assist in indicating traffic patterns or may indicate that a majority of recipients are not available along a particular route plan, and as such, an alternate route plan may be quicker or more likely to have successful deliveries to recipients.

Candidate-route plans engine 240 is generally responsible for determining a set of candidate routes and plans, and corresponding parcel transporters, such as parcel transporters 150 described with respect to FIG. 1. Candidate-route plans engine 240 may determine the set of candidate routes and plans continuously, periodically, or as needed. In some cases, candidate-routes plan engine 240 may determine candidate routes that begin at a specified time, such as the beginning of a shift, e.g., a predetermined time when a majority of transporters begin implementing route plans to deliver parcels. In some cases, the data utilized to determine the set of candidate routes may be derived from data collection 208 or any data stored in storage 220. In general, candidate-route plans engine 240 may predict transportation parameters, such as expected time to delivery or pickup of a parcel, which may include the amount of time that it will take a transporter to pick up a parcel at a pickup location; expected locations at predicted times along a route segment or route plan; expected energy consumption for a parcel transporter, such as the expected battery or fuel to be expended along a route or route plan; details on any potential hand offs, such as a transition from one transporter type to another; the capacity and payload information of a transporter; and similar parameters associated with routes and route plans. In some cases, candidate-route plans engine 240 may utilize route prediction logic to determine a set of candidate route plans, which may be based on historical data and prediction models derived from supervised and unsupervised training.

Route plans may be determined for many types of parcel transportation scenarios. For example, route plans may be determined using one or more of any type of transporter, such as terrestrial, aquatic, aerial, manned, unmanned, hand delivery, and the like. Generally, a route plan specifies a path between a beginning parcel location and an end parcel location. In embodiments here, a beginning parcel location could be a carrier pickup location, a customer drop off location, etc. Additionally, an end parcel location could be a delivery location of a parcel. Route plans may comprise one or more routes (e.g., routes may be individual segments of a route plan and each route or segment may be associated with a transporter). As an example, a route plan may comprise two routes, one route that may be traversed by a manned parcel transporter and another route that may be traversed by a UAV. In this example, the route plan may begin with a parcel being transported by the manned transporter at the beginning parcel location, a hand off may occur between the manned transporter and the UAV, and the route plan may end with the UAV navigating the parcel to the end parcel location. In some embodiments, route plans may be determined for various scenarios or forecasted scenarios, such as a 50% chance of rain; high winds; heavy traffic patterns; isolated traffic events, such as a traffic accident; temporary no-fly zones, such as sporting events or parades; and the like.

In some cases, routes and route plans may be static. For instance, each stop along the route or route plan may be previously specified, determined, and ordered. In some cases, routes and route plans may be dynamic or conditional. For example, a dynamic or conditional route plan may be a route plan conditioned or based on a particular event occurring. In some cases, conditional routes and route plans may be based on potential or predicated events, such as changes in the number and location of stops along a route plan, which may occur as customers request additional deliveries or pickups. In some cases, routes may be dynamic or conditional to account for changes in environmental factors such as the weather; traffic patterns; unexpected obstacles, such as delivery to a specified or determined alternative delivery location; and other similar events. Routes may also be conditional based on other emergent or unexpected events, such as damage to the transporter or an emergency occurring while delivering or picking up a parcel, or a transporter not being present at a hand-off location at a specified or predicted time.

In some cases, routes or route plans may be general ranges/areas to be patrolled or traversed. For example, a route plan may specify that a particular transporter is be located near a general geographic area, such as a terrestrial vehicle driving to a general area to await pickup/deliveries of parcels by aerial vehicles or by other customers. In some cases, this may include a transporter that is stationed at a particular geographic area. In some cases, this may include more than one transporter stationed at one or more locations throughout a geographic area or region, such as an assigned or fixed location. For example, one or more UAVs may be stationed at one or more assigned locations awaiting instructions to pick up, deliver, or more generally, to transport a parcel; instructions for traversing a route or route plan; or other received logistics instructions.

Routes and route plans information 232 may include historical, real-time, or predicted information regarding particular routes and route plans, which may be stored in storage 220. For example, route and route plans information may include the navigation data determined by candidate-route plans engine 240. Other examples may include previous lengths of time taken to implement routes or route plans, successful and unsuccessful delivery/pickup attempts or hand off attempts along various routes and route plans, previous adjustments or frequency of adjustments to implemented route plans, amount of idle time associated with transporters that implemented previous routes and route plans, the amount of time an employee operating a transporter may spend out of a manned parcel transporter to deliver a parcel to a delivery location, and the like.

In some cases, candidate-route plans engine 240 may update previously determined route plans. For example, a route plan that is currently being implemented or a route plan that will be implemented may be updated or adjusted. In some cases, the route plans may be adjusted or updated based on a change in the delivery location, such as when the consignee changes the delivery address or is moving, which may be determined through real-time positioning data of the recipient In some cases, the route plans may be adjusted based on new pickup or delivery requests. For example, candidate-route plans engine 240 may receive an indication of a new stop, such as a pickup of a parcel. Candidate-route plans engine 240 may determine that a currently implemented route plan or one that is to be implemented has sufficient time in the route plan to pick up the parcel and complete the objective of the original route plan. This may be determined, for example, by predicting the time the transporter will complete its objective if the transporter is dispatched to pick up the new parcel. If the predicted time of completing its objective is still within a threshold time frame, such as a time frame specified for delivering a parcel, and if the transporter has sufficient range available to pick up the new parcel and complete its original objective, then the original route plan may be updated or adjusted to provide for picking up the new parcel prior to or after completing the objective associated with the original route plan. In this case, the transporter may be dispatched to pick up the new parcel from the new pickup location. In some cases, a route plan for delivering the new parcel may be determined so the new parcel may be delivered by the same transporter that picked up the new parcel. Some methods for dynamically updating a dispatch plan to deliver the new parcel utilizing the same transporter may be found in U.S. Pat. No. 7,624,024, which is hereby expressly incorporated by reference in its entirety. In some cases, candidate route plans engine 240 may determine that a newly retrieved parcel needs to be delivered to a center associated with the transport of parcels, passed to another delivery transporter, or delivered by determining candidate route plans for transporting the newly picked up parcel. In this manner, the newly picked up parcel is ingested into the delivery process. Additional methods for determining whether a parcel should be passed off to another transporter and/or delivered to a center may be found in U.S. Patent Publication No. 2016/0071056, which is hereby expressly incorporated by reference in its entirety. In some cases, candidate-route plans engine 240 may comprise the following subcomponents: available transport determiner 242, range determiner 244, routes generator 246, and route-plan assembler 248. These subcomponents may perform a function that enables candidate-route plans engine 240 to determine a set of candidate routes and plans. In some embodiments, these functions may be performed utilizing candidate route plans logic 215.

Route plans logic 215 generally comprises rules, conditions, associations, classification or prediction models, pattern inference algorithms, or other criteria used for determining routes, route plans, or to facilitate carrying out other functions of candidate-route plans engine 240. Some embodiments of route plans logic 215 may utilize pattern recognition, fuzzy logic, neural network, finite-state machine, support vector machine, logistic regression, clustering, or machine learning techniques, similar statistical classification processes, or combinations of these processes. For example, the route plans logic 215 may comprise the logic used for determining or predicting the availability, range, and potential routes of transporters, and may be used to assemble routes into route plans based on predicted navigation data associated with the route plans being within certain constraints, for example, that the delivery/pickup of a parcel must be made to a particular location within a particular timeframe. In some cases, this may be determined or predicted using parcel transporter data 234 and navigation data received from sensors 120 and data collectors 140 of FIG. 1. In some embodiments, patterns may be determined based on historical navigation data, such as patterns in traffic flow, patterns in energy consumption rates of transporters, patterns in delivery times, and the like. Candidate-route plans engine 240 may utilize route plans logic 215 in conjunction with historical information, and in some embodiments may additionally utilize real-time obtained navigation information, such as, current transporter location, current transporter energy levels, current weather conditions, current traffic flow rates, etc., to predict or determine availability of transporters, range of transporters, the potential routes of transporters, and to assemble routes into route plans.

Available transport determiner 242 generally determines potential parcel transporters that available to pick up a parcel and/or available to transport a parcel along a route or route plan, such as by using route plans logic 215. In some cases, available transport determiner 242 may determine the available parcel transporters by receiving location information of the parcel transporters, such as from sensors 120. In some embodiments, available transport determiner 242 may determine available parcel transporters from a list of parcel transporters that may be stored within storage 220. This list may be updated by available transport determiner 242 and stored within storage 220 continuously, periodically, or as needed. In some cases, determining the available parcel transporters may include predicting the availability at a future time. For example, a particular transporter may not be currently available, but it may predict availability based on determining that the transporter will finish a particular route at a particular time. In another example, a particular transporter may not be available currently because of its location, but its predicted future location may make the transporter available. In another example, available transport determiner 242 may determine that a particular parcel transporter is currently available, but predicts that it will not be available at particular times in the future based on the transporter's future energy level, for example, a UAV having a rechargeable fuel cell may not have enough power to make the requested delivery. These are just a few examples of how available parcel transporter determiner 242 may determine or predict availability of a transporter; however, in general, any of the navigation variables discussed in the embodiments of this disclosure may be used in predicting the availability of a particular transporter.

In some cases, available transport determiner 242 may identify or determine transporters having a predicted or anticipated location within a threshold distance from a pickup location of a parcel. For transporters that are already engaged in implementing a route plan, predicting or anticipating their location may be based on an analysis of the remaining route plan and/or the individual routes for the transporters engaged in implementing the route plan. In some cases, this analysis may determine if a transporter engaged in implementing at least one of the routes in the route plan will pass within a threshold distance and could be rerouted to make the pickup. In some cases, this may include determining whether the transporter can make the pickup at the pickup location at a requested time or during a requested timeframe.

Range determiner 244, in general, determines or predicts one or more ranges and/or similar predicted operating parameters for the available parcel transporters. In some cases, a transporter's range may be determined based on historical and real-time navigation data. Using this navigation data route plans logic 215 may determine or predict the one or more ranges. For example, a UAV may be available for a delivery route that is within a particular radius based on its available energy supply. For example, the UAV may be available for a delivery over a longer distance in one direction versus another direction because of wind directions, whether current or predicted. In some cases, the UAV may have various ranges when transporting various size and weight parcels. Range determiner 244 may make these range predictions using the enriched data from any sensor or data source, such as those components in FIG. 1 or any available information in storage 220. Range determinations and predictions for a transporter may be stored in storage 220.

In some cases, the determined or predicted range of a transporter may be dynamic. For example, a transporter may have a particular range while carrying a certain weight. However, as parcels are unloaded, the range may increase due to lower weights. In some cases, the range determiner may continuously determine and predict ranges for a transporter. In some cases, predicted ranges may be based on the probability that certain parcels of certain weights will be unloaded from the transporter. For example, the probability that certain parcels will be unloaded may be based on stored historical route or route plan information, such as routes and route plans information 232, and predicted by route plans logic 215.

In some cases, range determiner 244 may use historical navigation data to determine or predict the range of a transporter. For example, a human transporter may have a range that is individualized to that particular person, such as the average distanced walked by the person or a maximum distance the person should walk. In some cases, this data may be determined from carrier computing device 165 (FIG. 1) and stored on storage 220. In some cases, different human transporters may have different historical averages for range. Based on this information, a prediction may be made as to a particular transporter's range. For example, one human transporter may have a greater average range, but the predicted range may be lower at a certain time if that person has already been walking for part of their scheduled shift, or if that person will not be at work at the future time. However, another person with a lower average range may have a higher predicted range if that person is just starting a shift. Similarly, in some cases, a UAV may historically have an average range that is greater during evening times because of lower temperatures. As such, range determiner 244 may predict a greater range for delivery time occurring in the evening. As another example, a terrestrial vehicle may have a particular average range, but this range may be reduced based on traffic patterns or infrastructure, e.g., heavy traffic or higher numbers of traffic lights.

Routes generator 246 generally determines a set of potential routes. In some cases, these routes may correspond to a particular type of available parcel transporter. The set of potential routes may account for restrictions for the various types of transporters. For example, terrestrial vehicles may be restricted to certain predefined types of infrastructure, such as roadways. Similarly, the set of potential routes may include avoidance of no-fly zones for UAVs, or use of pre-determined virtual highways enabled for UAV traffic. In some cases, an available parcel transporter may be available for multiple potential routes determined by routes generator 246. In some cases, routes generator 246 may predict potential routes for transporters using route plans logic 215 and may be based on historical and real-time information, such as navigation information collected from sensor 120 or data collectors 140, as described above with references to FIG. 1, and/or storage 220. For example, if there is a chance of precipitation at a particular time, a UAV may have a predicted route which assumes no rain and another predicted route which accounts for rain.

Route-plan assembler 248 generally determines route plans using the potential routes determined by routes generator 246. For example, a route plan may be an assembly of one or more of the potential routes. In some cases, route plans may comprise one or more of the potential routes assembled together from a beginning parcel location to an end parcel location, which in some cases will respectively be a pickup location and a delivery location. In some cases, a route plan may include one type of parcel transporter or several types of parcel transporters, and may include hand offs between the same or different types of transporters. For example, a terrestrial transporter may be utilized to transport a parcel over a first route of a route plan, and a hand-off made to a UAV that may transport the parcel over a second route of the route plan, which in some cases may include a UAV that is associated with or transported on the terrestrial transporter. Another example of a route plan comprises a manned parcel transporter that transports a parcel over a first route that starts at a beginning location, and a hand off made to a manned transporter that transports the parcel over a second route of the route plan that terminates at an end location.

In some embodiments, candidate route plans are assembled such that each member route in a candidate route plan starts at either the parcel pickup location or at the end of another route, and each route ends at either the start of another route or the package delivery location. In other words, a candidate route plan is assembled such that it comprises one or more routes joined together in a series such that a package traversing the routes would be transported from pickup to delivery location. For example, suppose a package is to be transported from location A to location F. A first candidate route plan may comprise three routes: route 1, from location A to location C, which may be implemented using a manned truck; route 2, from location C to location E, which may be implemented using an unmanned terrestrial vehicle; and route 3, from location E to location F, which may be implemented using a UAV. A second candidate route plan may comprise two routes: route 1′, from location A to location E, which may be implemented using a manned truck; and route 2′, from location E to location F, implemented using a UAV. Note further that in this example, route 2′ may be similar or even identical to route 3, however the timings of the transfers may be different and thus each route may be different even though each starts and ends at the same location and uses the same transport type, i.e., an aerial unmanned vehicle. Additionally, in some instances as described herein, a candidate route plan may comprise only one route or a plurality of routes.

In this way, when circumstances change and an implemented route plan is no longer feasible or becomes too costly to carry out (which may be determined by route plan implementation evaluator 260), then an alternative route plan may be implemented. In some embodiments, the alternative route plan may comprise a candidate route plan with the next best ranking or score with regards to the implemented candidate route plan. In some embodiments, the alternative route plan may comprise modifying aspects of one or more routes within the implemented route plan (e.g., using an unmanned terrestrial vehicle instead of a UAV, modifying start/ending locations or times for routes within the candidate route plan, or transfer times or transfer parameters occurring when a transport vehicle on one route transfers a parcel to a second transport vehicle on another route within the implemented route plan). In some instances the alternative may comprise selecting or generating an alternative route plan and implementing the alternative route plan in place of the original route plan, or the remaining portion of the original route plan that has not yet been implemented.

As described herein, routes may be assembled into route plans using route plans logic 215. In some embodiments, each candidate route determined by routes generator 246 has a corresponding vector of values representing objective parameters that may be weighted based on preferences or settings. (For example the objective parameters may be weighted to indicate greater importance on reducing shipping time or minimizing shipping costs, as further described below.) Route plans logic 215 may include logic for scoring each route plan based on the vectors of its constituent routes. For instance, in one embodiment, each route vector of a candidate route plan may be summed together with other route vectors of the candidate route plan to generate a composite candidate route plan vector or candidate route plan score. Multiple candidate route plans then may be ranked based on their respective scores. For example, the candidate route plans may be ranked lowest to higher, where a lower score is better or vice versa. In some embodiments, route plans logic 215 may include instructions for modifying the score based on the number of routes included in a candidate route plan; for instance, a penalty could be imposed for each additional route or for candidate route plans that include more than a certain number of constituent routes. This has the effect of de-emphasizing or de-prioritizing candidate route plans with excessive numbers of routes and thus prioritizing those plans with fewer routes. In other words, in these embodiments, the inefficiencies introduced by package hand offs that occur where one route ends and another begins are reflected in the candidate route plan score. In some embodiments, route plans logic 215 may specify using other scoring evaluative processes; for example, in one embodiment, TOPSIS (Technique for Order of Preference by Similarity to Ideal Solution) decision making may be utilized.

In some cases, one or more route plans may be generated by route-plan assembler 248 to provide for transporting a parcel from a beginning location to an end location. In this sense, the one or more route plans may be candidate route plans, e.g., one or more route plans that may accomplish the same objective, such as defining a route plan for transporting a parcel from the beginning to the end location. In some cases, each of the candidate route plans may have determined or predicted navigation data, for example, the types of transporters used, the predicted time to transport the parcel from the beginning location to the end location, the number of hand offs, predicted transporter energy consumption, and other similar navigation information. The navigation information associated with the candidate route plans may be predicted utilizing route plan logic 215. For example, a route plan may have a predicted amount of energy consumption over the route plan, including a predicted energy consumption for each parcel transporter associated with the route plan. In some cases, times may be predicted or determined from the beginning location to the end location, and in some cases, the times may further be predicted for each route along the route plan, e.g., this may include the predicted time the parcel begins at the beginning location, a predicted time for a transporter at any location along a route of the route plan, a predicted time for each, if any, hand-offs along the route plan, and/or a predicted time a transporter is at the end location with the parcel.

In some cases, the candidate route plans may be isolated or interdependent. For example, isolated route plans may not affect each other. Put another way, one is not dependent or altered by another route plan. By way of working example, one route plan may encompass a manned vehicle and a UAV to transport a parcel from a beginning parcel location to an end parcel location. This plan may not affect another plan utilizing a manned vehicle and a human to deliver a different parcel. Altering or creating one route plan does not affect the other. In this sense, the route plans are isolated.

In some cases, candidate route plans may be interdependent. For example, the use of one resource over one part of the route plan may affect another route plan. By way of working example, a first candidate route plan may include utilizing a manned vehicle and a UAV to transport a parcel over the route plan. A second candidate route plan may include using the same manned vehicle. These route plans would be considered interdependent. In some cases, for example, when interdependent route plans are used to transport parcels or new interdependent route plans are generated to account for new information, such as a new parcel pickup/delivery request, route-plan assembler 248 may dynamically adjust, modify, create, and/or remove candidate routes continuously, periodically, or as needed. The adjusted, modified, new candidate route plans may be stored in storage 220, for example, as routes and route plans information 232.

Candidate route plan evaluator 250, in general, may evaluate candidate route plans, as determined by candidate-route plans engine 240. In some cases, candidate route plan evaluator 250 may rank the candidate route plans based on one or more criteria. For example, in some embodiments, the ranking may be based on tunable or weighted parameters, such as objective weightings corresponding to goals or priorities of the logistics system operator, such as the carrier. The parameters are tunable in the sense that different corresponding objectives or goals may take different service levels based on factors determined by a parcel carrier, the shipper, the recipient, or other interested party, which may be changed or combined (i.e., tuned). For example, a parcel may be sent by a sender/shipper through a parcel carrier service to a recipient. The sender may designate the service level, such as Same Day Delivery, Next Day Air, and so on. In doing so, the parcel carrier may have a priority or goal to reduce the shipment time. This goal of reducing shipping time may be associated with a weighted objective value, such as minimizing transportation time. In some cases, a weighted value may be adjusted based on a goal or objective by the carrier to reduce energy expenditure over delivery routes. Still in other instances, an objective may be to transport a parcel so as to reduce shipping cost to the sender, while forgoing a short delivery time. In this case, a lesser weight may be placed on parameters corresponding to a shorter delivery time. In general, a weight may be based on objectives or preferences of any of the interested parties. Other examples may include preferences of the carrier to reduce hand offs, or to limit the amount of fuel expended to deliver a parcel; a preference of the shipper to limit the shipment time, to not use aerial delivery, such as if the contents are volatile or dangerous, or to use extra care if the contents are fragile; and/or it may be the preference of the recipient to deliver the parcel during certain times, use an alternative delivery location, or to not use UAV delivery; and so on. The weighted objectives or parameters may be stored in storage 220, for example, as objective weightings 233.

Each of these parameters and any other objectives may be given a dynamic weight that may be utilized by candidate route plan evaluator 250 when evaluating and ranking candidate route plans. In some cases, dynamic re-ranking or dynamic evaluation of candidate route plans may occur after receiving a notification from route plan implementation evaluator 260 and/or as notification of implemented failsafe procedures, further discussed below.

In some cases, candidate route plan evaluator 250 may determine if an indicated goal may be accomplished by any of the candidate route plans. For example, if a customer requests Same Day Delivery, candidate route plan evaluator 250 may determine, from among the candidate route plans, if one or more of the candidate route plans meets the Same Day Delivery service level by having a predicted delivery time that falls within the criteria for the designated service level. In some cases, the candidate route plan evaluator 250 may rank the candidate route plans meeting the criteria for the service level. In some cases, if no candidate route plan meets the criteria for the requested service level (or more generally, a requested goal), a notification may be provided to the customer that the requested service level is not available. In some cases, the notification may comprise a suggested service level for the customer based on the candidate route plans. For example, if Same Day Delivery is not available, then a notification may be provided to the customer indicating another service level, such as Next Day Air, based on at least one candidate route plan that may deliver the parcel in the time frame specified by the Next Day Air service level. Using another example, a customer may request a goal of picking up a parcel during a specific time frame. In this case, candidate route plan evaluator 250 may determine and rank the candidate route plans having a pickup time within the specific time frame requested by the customer.

In some cases, candidate route plan evaluator 250 may communicate a ranking, e.g., a ranked set of candidate route plans (or a subset of ranked plans, such as the top ranked candidate route plan or portion of the top ranked candidate route plans) via network 110 to one or more other components of system 200 so that one of the evaluated route plans may be implemented, i.e., parcel transporters 150 of FIG. 1 receive the route plan information and navigate the route plan in accordance with the information received from candidate route plan evaluator 250. In some cases, the highest ranked route plan may be communicated by candidate route plan evaluator 250 for implementation.

In some embodiments, based on objective weightings and navigation data received or derived from the components of FIG. 1 and/or from storage 220, candidate route plan evaluator 250 may evaluate and rank the routes utilizing candidate route plan evaluator logic 216. The routes may be evaluated and ranked continuously, periodically, or as needed. Thus, candidate route plan evaluator 250 may evaluate routes dynamically as new information is received. In some embodiments, the highest ranked route plan is the plan that is implemented at any one time to transport a parcel from a beginning location to an end location.

In general, route plan evaluator logic 216 comprises the rules, classification and prediction models, pattern inference algorithms, and other criteria (including regulatory, technological, or operational modifiers), which are used to evaluate and rank the set of candidate route plans. Route plan evaluator logic 216 may use pattern recognition, fuzzy logic, neural network, finite state machine, support vector machine, logistic regression, clustering, or machine learning techniques, similar statistical classification processes or, combinations of these to evaluate and rank the set of candidate route plans. In some cases, using route plan evaluator logic 216, candidate route plan evaluator 250 may evaluate and rank the set of candidate route plans using the weighted objectives.

Route plan implementation evaluator 260 generally evaluates implementation of route plans. In some cases, route plan implementation evaluator 260 comprises subcomponent failsafe 262. In some cases, route plan implementation evaluator 260 monitors the progress of one or more implemented route plans simultaneously, such as multiple route plans that are being implemented during a shift. To evaluate the implementation of one or more route plans ranked and selected by candidate route plans evaluator 250, route plan implementation evaluator 260 receives real-time or near real-time information, such as information from sensors 120 and data collectors 140 of FIG. 1. To evaluate implementation of route plans, route plan implementation evaluator 260 may utilize route plan implementation logic 217, for example, to compare predicted navigation values to real-time or near real-time measured values. For example, route plan implementation evaluator 260 may compare the predicted navigation values for an implemented route plan, such as the predicted time of pickup and delivery, and predicted times and locations of transporters implementing route plans, with real-time measured times and locations for the transporters to evaluate the implementation of one or more routes plans.

In general, route plan implementation evaluator 260 may receive data collected via sensors 120 and/or data collectors 140, described with respect to FIG. 1, and/or may receive navigation information from storage 220. In some cases, when route plan implementation evaluator 260 receives information about a route plan during implementation which does not match information previously predicted about the route plan, route plan implementation evaluator 260 may communicate with candidate route plan evaluator 250 and/or candidate-route plans engine 240 to dynamically determine a new or altered route plan. For example, in some cases, an implemented route plan that is determined to be deviating from the route plan may not be altered, but rather, implementation evaluator 260 may continuously monitor data associated with the route plan. Parameters related to the actual implementation of the route plan, such as real-time locations of transporters at particular times, may be communicated to candidate-route plans engine 240 and/or candidate route plan evaluator 250. In some cases, candidate-route plans engine 240 may predict a set of candidate route plans that include the predicted completion of the implemented route plan. Candidate route plan evaluator 250 may rank the set of candidate route plans, including the predicted completion of the implemented route plan. In some cases, a candidate route plan in the set of candidate route plans may rank higher than the current implemented route plan. The new, higher ranked candidate route plan may be implemented in addition to or in lieu of the current plan. In this sense, the implemented route plan, being monitored by route plan implementation evaluator 260, may be modified or abandoned, and an adjusted or new route plan may be implemented. For example, if the actual transportation time along an implemented route plan is greater than predicted, and time parameters for another candidate route plan are closer to the predicted times, the candidate route plan with the closer time parameters may be implemented to transport the parcel, thereby modifying or abandoning the previous implemented route plan.

In general, route plan implementation logic 217 comprises the rules, classification and prediction models, pattern inference algorithms, and other criteria which are used to monitor the implementation of a route plan. Route plan implementation logic 217 may use pattern recognition, fuzzy logic, neural network, finite state machine, support vector machine, logistic regression, clustering, or machine learning techniques, similar statistical classification processes, or combinations of these to monitor the implementation of a route plan. For example, route plan implementation evaluator 260 may utilize route plan implementation logic 217 to compare real-time navigation information to predict navigational information to monitor the route plan.

In some cases, route plan implementation evaluator 260 may provide a notification, via user interface 205, to an interested party, such as the shipper, the carrier, the recipient, or the like. In some cases, the notification may comprise a request for additional instructions. In some cases, the notification may provide additional details about the new or adjusted route plan, for example, arrival time, transporter-type information, delivery location, and so on.

In some cases, failsafe 262 may initiate failsafe procedures in response to emergency situations involving transporters. In some cases, an emergency situation may be determined by real-time monitoring of a transporter by route plan implementation evaluator 260. For example, real-time parameters associated with implemented route plans may be monitored by route plan implementation evaluator 260 utilizing sensors 120 and data collectors 140 of FIG. 1. Failsafe 262, in some cases, may be defined based on the type of parcel transporter, and may generally specify an emergency mode of operation. Failsafe procedures may be stored on storage 220 and initiated based on the monitoring. In some cases, failsafe 262 may be implemented by the transporter based on navigation information received by the transporter during implementation of the route. For example, if a UAV measures a non-predicted drop in altitude using an on-board altimeter, it my initiate failsafe procedures based on this measurement. In some cases, if real-time (or near real-time) data indicates a route plan may not be completed due to unforeseen circumstances, failsafe instructions may be applied to a transporter along the route that could not be completed. For example, while a route plan may have associated predicted variables, such as predicted weather events or predicted traffic information, the measured outcomes of those variables, such as actual weather events or actual traffic conditions, may vary. When the actual and predicted values differ, in some cases, failsafe procedures may be initiated in some circumstances.

By way of working example, a UAV may attempt to make a delivery or pickup at a location and may navigate the entirety of or a portion of a route plan. If a mechanical failure occurs or an unexpected weather event does not permit the UAV to continue traversing the route plan, failsafe 262 may provide instructions to the UAV that require it to land in the nearest open area, return to its original location (which, in some cases, may include traveling in reverse along the same path or traversing a different path, and may occur at the same altitude or a different altitude), traverse to the nearest carrier location, and so forth. In some cases, failsafe procedures may include sending a notification to the carrier or other interested party that failsafe procedures have been implemented. In some instances, failsafe procedures may provide for a human operator to take control of an unmanned transporter from a remote location. In some cases, failsafe procedures may include communicating an instruction to candidate-route plans engine 240 and/or candidate route plan evaluator 250 to include an additional stop to pick up a parcel associated with the transporter that implemented failsafe procedures, and/or to modify or abandon the implemented route plan in accordance with embodiments described herein. For example, if a UAV carrying a parcel implements a failsafe procedure that causes the UAV to make a controlled landing, candidate-route plans engine 240 may include the site where the UAV landed as a location along a set of candidate route plans in order to pick up the parcel and continue the delivery. A new set of route plans may be created or an existing set altered by candidate-route plans engine 240, and a route plan ranked and selected by candidate route plan evaluator 250 that includes retrieving the parcel from the landing site.

Route plan map generator 270, in some cases, may generally provide an enriched map of estimated delivery/pickup times based on enriched data. In some cases, this may include routes from candidate-route plans engine 240 and/or candidate route plan evaluator 250. In some cases, the map generated by route plan map generator 270 may be based on historical navigation activity, such as routes and route plans, and may be used to estimate costs and/or delivery times for the same or similarly routes and route plans if subsequently used to transport parcels. This may be stored in storage 220 for later use by system 200 or, in some cases, may be transferred by the carrier to other parties that may be interested in enriched route plans.

Datastore or storage 220 generally stores information including data, computer instructions (e.g., software program instructions, routines, or services), and/or models used in embodiments of the technologies described herein. In an embodiment, storage 220 comprises a data store (or computer data memory). Further, although depicted as a single data store component, storage 220 may be embodied as one or more data stores or may be in the cloud. Additional aspects of storage 220 are described with respect to exemplary computing device 600 of FIG. 6. As shown in example system architecture 200, storage 220 includes: customer account information 231, routes and route plans 232, objective weightings 233, parcel transporter data 234, and route plans logic 215, route plan evaluator logic 216, route plan implementation logic 217, which have been described in accordance with aspects herein.

Customer account information 231 may include data that is associated with a customer or user. For example, this may be customer preferences collected using a smartphone logistics app, e.g., relating to customer payment information, customer's address, parcel delivery addresses(s), etc. Customer account information 231 may include, for example, user created rules such as no-fly zones, release/retrieve points, alternative delivery locations, do-not-deliver times, preferred delivery times, number of times the customer sends and receives parcels, customer's preferences on using unmanned delivery systems, other individuals authorized by the customer to retrieve the customer's parcel, whether or not to leave a parcel at the delivery location if a customer is not present, customer insurance preferences, and the like. Customer account information 231 may also include learned information such as patterns associated with the customer. For example, if delivery of one or more parcels to a particular location is not successful because the customer is not present at the location at the time the deliveries are made, a pattern may be determined that the customer is typically not present at the location at a particular time. Thus, delivery may be delayed until a time when a customer is more likely to be home. Other patterns associated with the customer may be how often the customer ships or receives parcels, the typical size of the parcels shipped or received, and whether the recipients are the same or different for the shipments.

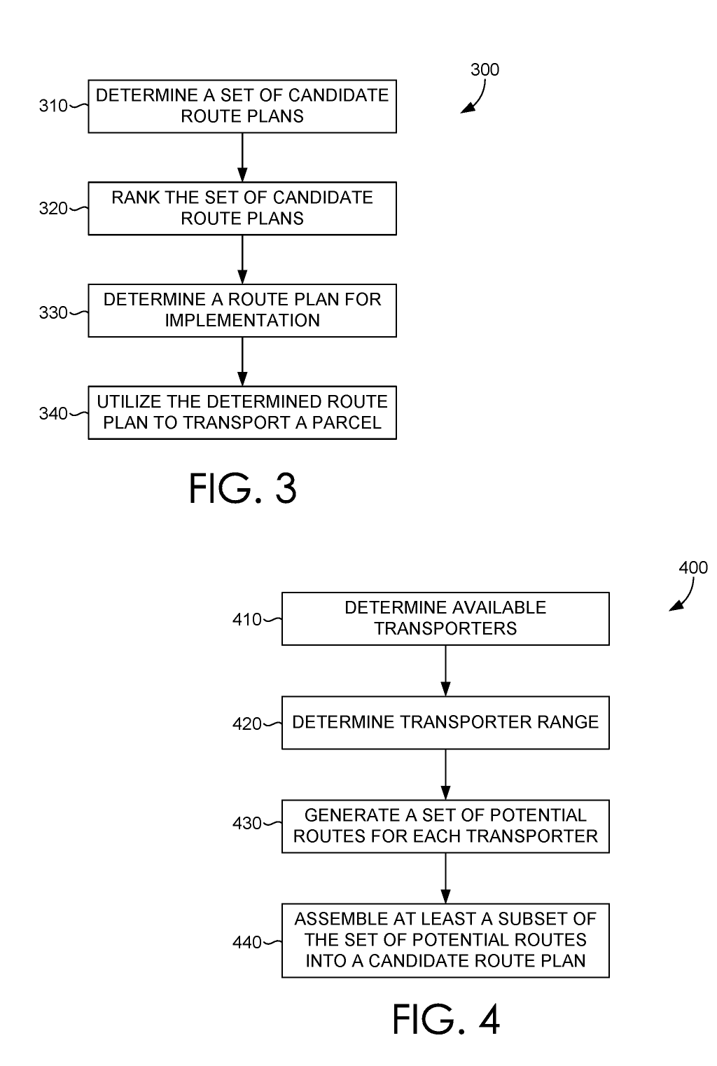

Turning now to FIG. 3, FIG. 3 illustrates a block diagram showing exemplary method 300 for utilizing a determined route plan to transport a parcel. At block 310, a candidate-route plans engine, such as candidate-route plans engine 240 (FIG. 2) is used to determine a set of candidate route plans. In some cases, determining the set of candidate route plans may be performed using method 400 described below in conjunction with FIG. 4. At block 320, the set of candidate route plans is ranked. In some cases, the set of candidate route plans may be ranked using a weighted objective, such as a goal by the sender, the carrier, or the recipient to reduce delivery time, reduce delivery cost, and/or to reduce transporter power consumption. In some cases, the weighted objectives may be tunable, weighted goals.

At block 330, a route plan for implementation is determined. The route plan may be determined by selecting or determining the highest ranked candidate route plan. In some cases, the highest ranked route plan may be determined by candidate route plan evaluator 250 by ranking a set of candidate route plans based on one or more weighted objectives. At block 340, the determined route plan is utilized to transport a parcel from a parcel beginning location to a parcel ending location, which in some cases, may respectively be a pickup location and a delivery location. In some cases, all or portions of the route plan may be communicated to transporters that are associated with the route plan, so that the transporters may transport the parcel in accordance with the route plan.

Turning now to FIG. 4, FIG. 4 illustrates a block diagram of an exemplary method for determining a candidate route plan. At block 410, a candidate-route plans engine, such as candidate-route plans engine 240 (FIG. 2.), is used to determine one or more available transporters based on a plurality of transporters. Availability of a transporter may be based on historical, real-time, or predicted navigation data. For example, an available transporter may be a transporter that, based on predicted information, has an available power supply capacity to transport the parcel from a beginning to an ending location, and may further have the payload and capacity availability to physically transport the parcel. At Block 420, transporter range is determined. Transporter range may also be determined based on transporter data. For example, the transporter range may be based on transporter type, weather conditions, traffic conditions, and the like.

At block 430, a set of potential routes for each transporter may be generated. In some cases, potential routes may also be based on navigation data, and may take into account the range determined for the transporter at block 420. In some cases, the potential routes may be all the routes available to the available transporter based on power supply; traffic patterns; regulatory requirements, such as no-fly zones; and the like. At block 440, at least a subset of the potential routes determined at block 420 are assembled into a candidate route plan. For example, the candidate route plan may comprise a single route by a single transporter. In some cases, it may comprise a set of routes by more than one transporter or transporter type, and may include hand offs between the different transporters. In some instances, the candidate route plan may be one or more routes that are assembled from a beginning parcel location to an ending parcel location, for example, a pickup location and a delivery location of a parcel. In some embodiments the candidate route plan may comprise a segment or route for a first transporter to traverse prior to picking up the parcel, so that the parcel may be transported from the beginning to end location.

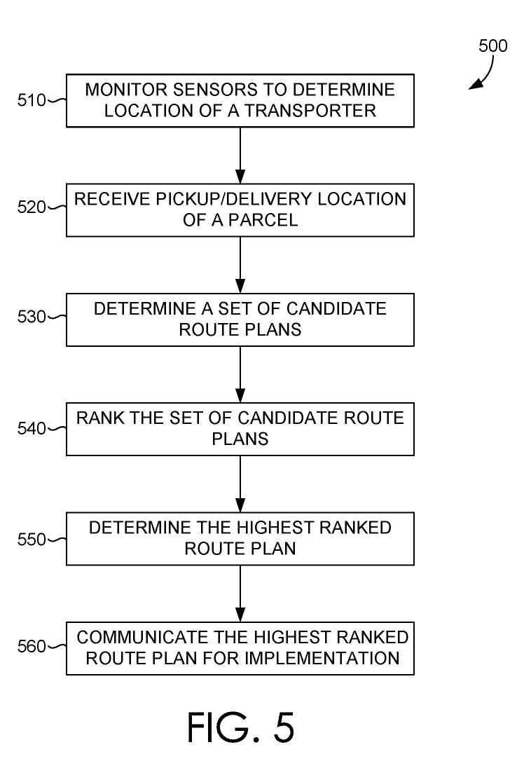

Referring now to FIG. 5, a block diagram of an exemplary method 500 for communicating a route plan for implementation is provided. At block 510, sensors are monitored to determine a location of a transporter. In some cases, sensors may be monitored by candidate-route plans engine 240 using sensors 120 or data collectors 140 (described in discussion of FIG. 1). In some cases, future locations may be predicted, for example, by candidate-route plans engine 240 using route plans logic 215. At block 520 a pickup/delivery location of a parcel is received. This may be received by a carrier from a shipper, receiver, or other interested party. In some cases, a pickup location may be designated as a beginning parcel location and a delivery location may be designated as an end location. At block 530 a set of candidate route plans is determined. This may be determined by candidate-route plans engine 240 using route plans logic 215, for example. In some cases, each candidate route plan of the set of candidate route plans may be determined by candidate-route plans engine 240 in the matter described above by method 400.

At block 540, the set of candidate route plans may be evaluated and ranked. For example, candidate route plan evaluator 250 may rank the candidate route plans using route plan evaluator logic 216 based on a set of weighted objectives. At block 550, the highest ranked route plan of the candidate route plans is determined. At block 560, the highest ranked route plan may be communicated in whole or in part to parcel transporters that are associated with the route plan. In some cases, the parcel transporters will implement the route by navigating along the route in accordance with the route plan.

Referring to the drawings in general, and initially to FIG. 6 in particular, an exemplary operating environment for implementing aspects of the technology described herein is shown and designated generally as computing device 600. Computing device 600 is but one example of a suitable computing environment and is not intended to suggest any limitation as to the scope of use of the technology described herein. Neither should the computing device 600 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, and an illustrative power supply 622. Bus 610 represents what may be one or more busses (such as an address bus, data bus, or a combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory 612 may be removable, non-removable, or a combination thereof. Exemplary memory includes solid-state memory, hard drives, optical-disc drives, etc. Memory 612 does not comprise non-statutory signals per se. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, vibrating component, etc. I/O ports 618 allow computing device 600 to be logically coupled to other devices, including I/O components 620, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 600. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include a radio 624. The radio 624 transmits and receives radio communications. The computing device may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Exemplary Use Scenarios:

Exemplary use scenarios are provided to give some context to the technology described in this disclosure. They are not intended to be an exclusive set of examples.

Exemplary scenario 1: At a store, a shipper requests a carrier to deliver a parcel to a delivery location. The shipper specifies the delivery location and a timeframe for delivery. Based on the location where the parcel was received and the delivery location, the logistics system utilizes enriched data to determine the route plan and then implements the plan. In this scenario, the logistics system determined that a first route segment would be traversed by a manned terrestrial parcel transporter, and a hand-off of the parcel made to a UAV, which would traverse a second route segment with the parcel, where the second route segment ends at the delivery location. The route plan, comprising the first and second segment, is implemented by the parcel transporters. Further details of this example scenario are descried below in exemplary scenarios 2-7.

Exemplary scenario 2: In exemplary scenario 1, as part of determining the route plan, the logistics system determined the availability of all transporters that could be utilized to make the delivery. In this scenario, to determine availability, the logistics system analyzes the predicted locations of the transporters, the predicted power supply available to the transporters, the predicted loads and capacities of the transporters compared to maximum loads and capacities, and predicted weather and traffic patterns. Based on this information, it is determined that the manned transporter, UAV, and other transporters would be available at the time needed to transport the parcel. For example, the predicted weather patterns are suitable for delivery by the UAV. In some cases, the availability of certain transporters may be based on customer preferences, such as the recipient's preferences on UAV delivery.

Exemplary scenario 3: The logistics system further determines the ranges and routes that may be traversed by each of the available transporters that were determined in exemplary scenario 2. In this scenario, the ranges and routes are determined by predicted fuel consumption rates, predicted weather and traffic patterns, and predicted payload and capacity availability. For example, some routes for UAVs are shorter because of wind blowing from a particular direction, and some routes by manned terrestrial transporters are shorter because of traffic patterns and road infrastructure design.

Exemplary scenario 4: The logistics system further determines a set of candidate route plans. These candidate route plans consist of one or more of the routes determined in exemplary scenario 3. Put another way, the candidate route plans show the combination of the routes that will transport the parcel from the store (the drop-off location) to the delivery location. Each of these plans has associated predicted values that are determined by the logic criteria described previously and are based on historical, measured, and received information. For example, these include the times and locations predicted over the route plan for each of the transporters, the hand-off locations and times, predicted power usage and cost, types of parcel transporters used, and the like.

Exemplary scenario 5: The logistics system ranks the set of candidate route plans determined in exemplary scenario 4. The candidate route plans may be ranked based on a weight that is placed on delivery preferences or goals. In this scenario, the timeframe goal and the goal of the carrier to minimize delivery costs provides for a weighted factor on which the candidate route plans may be ranked. For example, if there are 10 candidate route plans that meet the appropriate timeframe, the lowest delivery cost route plan may be ranked the highest and be selected for implementation. All preferences of the shipper, sender, receiver, or other interested parties may be weighted and balanced in this way to rank the candidate route plans.

Exemplary scenario 6: The logistics system communicates the highest ranked route plan determined in exemplary scenario 5 to the transporter systems for implementation. The transporter systems traverse the route plan in accordance with the received instructions.

Exemplary scenario 7: The logistics system monitors the implementation of the route plan from exemplary scenario 6 to determine if a new route plan, an adjustment to the route plan, and/or failsafe procedures need to be initiated. Here, the logistics system monitors the transporters during implementation. For example, it may monitor the actual time and location of the transporters, the actual power consumption of the transporters, the actual hand-off time, and the like. This information may be compared to the predicted variables to monitor the implementation of the route plan. By monitoring and comparing the actual route values with the predicted route values, the logistics system may determine if a new route plan, an adjusted route plan, or an emergency failsafe procedure needs to be initiated. The logistics system may monitor the transporters before and after the parcel is delivered by continuously and dynamically updating the route plans and the predicted variables and comparing the predicted variables with the actual, real-time or near real-time measured values.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope. Some exemplary embodiments include the following:

Embodiment 1: A logistics system for facilitating transport of a parcel, the logistics system comprising: a plurality of transporters, wherein the plurality of transporters comprises one or more unmanned aerial vehicles (UAVs); a data collection component that receives navigation data, wherein the navigation data comprises information used to determine a route plan for the transport of parcels; a candidate route plans engine; a candidate route plan evaluator; computer memory storing computer-usable instructions that, when executed by a processor, perform operations comprising: (i) determining, by the candidate route plans engine, a set of candidate route plans for transporting the parcel from a pickup location to a delivery location, wherein the determining of the set of candidate route plans is based at least on the navigation data, wherein each candidate route plan of the set of candidate route plans is determined by: identifying one or more available transporters from the plurality of transporters, wherein each of the one or more available transporters has an availability to transport the parcel based at least on the navigation data; determining a range for each of the one or more available transporters; based, at least, on the determined range for each of the one or more available transporters, generating a set of potential routes for each of the one or more available transporters; and assembling at least a subset of the set of potential routes into a candidate route plan for transporting the parcel from the pickup location to the delivery location; (ii) ranking, by the candidate route plan evaluator, the set of candidate route plans based on a weighted objective, the weighted objective comprising at least one of shipping time or a shipping cost; (iii) determining the route plan for implementation based on the ranking; and (iv) communicating the route plan to at least one available transporter associated with the route plan, wherein the at least one available transporter associated with the route plan utilizes the route plan to transport the parcel from the pickup location to the delivery location.

Embodiment 2: The system of embodiment 1, wherein the navigation data includes one or more of historical, real-time, or predicted weather information, traffic information, transporter location information, or payload and capacity information.

Embodiment 3: The system of embodiment 1 or 2, wherein the weighted objective further comprises transporter energy consumption.

Embodiment 4: The system of any of embodiments 1-3, wherein the weighted objective is determined based on a priority class associated with the parcel.

Embodiment 5: The system of any of embodiments 1-4, wherein the weighted objective is based on a set of tunable weighted goals.

Embodiment 6: The system of any of embodiments 1-5, wherein determining the route plan for implementation further comprises selecting a highest ranked candidate route plan.

Embodiment 7: A computerized logistics system comprising: one or more sensors configured to determine at least location information for a transporter; and a logistics server in communication with the one or more sensors, the logistics server having computer memory storing computer-useable instructions that, when executed by a processor, implement a method comprising: receiving, from the one or more sensors, location information for each transporter of a plurality of transporters, wherein the plurality of transporters comprises at least a manned transporter and an unmanned aerial vehicle (UAV), determining navigation data based, at least, on the location information, wherein the navigation data comprises information used to determine a route plan for a transport of parcels, receiving a pickup request that comprises a pickup location and a delivery location of a parcel, determining a set of candidate route plans for at least one available transporter of the plurality of transporters, wherein the set of candidate route plans is determined based, at least, on the navigation data, ranking candidate route plans within the set of candidate route plans based on one or more weighted objectives, the one or more weighted objectives comprising at least one of shipping time or shipping cost, based on the ranking, determining the route plan for implementation from the ranked set of candidate route plans, and communicating the route plan to the at least one available transporter for navigating the route plan to transport the parcel.

Embodiment 8: The system of embodiment 7, wherein determining the set of candidate route plans comprises: determining available transporters from among the plurality of transporters; determining a range of each of the available transporters; generating a set of potential routes for each of the available transporters; and assembling at least a subset of the generated set of potential routes into the set of candidate route plans from the pickup location to the delivery location.

Embodiment 9: The system of embodiments 7 or 8, wherein the navigation data includes one or more of historical, real-time, or predicted weather information, traffic information, transporter location information, or payload and capacity information.

Embodiment 10: The system of any of embodiments 7-9, wherein the one or more weighted objectives further comprise at least one of a number of transporter hand-offs or transporter energy consumption.

Embodiment 11: The system of any of embodiments 7-10, wherein the route plan comprises predicted times and predicted locations for each transporter associated with the route plan.

Embodiment 12: The system of any of embodiments 7-11, further comprising evaluating implementation of the route plan.

Embodiment 13: The system of any of embodiments 7-12, wherein evaluating the implementation of the route plan comprises: monitoring real-time location information from sensors associated with each transporter associated with the route plan; and comparing the real-time location information to the predicted times and the predicted locations.

Embodiment 14: The system of any of embodiments 7-13, wherein the real-time location information is different than the predicted times and the predicted locations.

Embodiment 15: The system of any of embodiments 7-14, wherein a new route plan is determined based on a difference between the real-time location information and the predicted times and the predicted locations.

Embodiment 16: The system of any of embodiments 7-15, wherein a new route plan is determined based on an additional pickup request.

Embodiment 17: The system of any of embodiments 7-6, wherein a failsafe procedure is implemented based on a difference between the real-time location information and the predicted times and the predicted locations.

Embodiment 18: One or more computer storage devices storing computer-useable instructions that, when used by one or more computing devices, cause the one or more computing devices to perform a method for determining a route plan that includes an unmanned aerial vehicle (UAV), the method comprising: receiving location information from one or more sensors associated with a plurality of transporters, the plurality of transporters comprising at least the UAV; receiving a pickup request for a parcel, the pickup request comprising a pickup location and a delivery location associated with the parcel; determining that one or more transporters of the plurality of transporters are available for transporting the parcel, the one or more available transporters comprising at least the UAV; determining a set of candidate route plans for picking up and delivering the parcel, wherein determining the set of candidate route plans is based, at least, on navigation data comprising one or more of historical, real-time, or predicted weather information, traffic information, transported location information, or payload and capacity information; ranking candidate route plans within the set of candidate route plans based, at least, on a weighted objective, wherein the weighted objective comprises at least one of a shipping time or a shipping cost; based on the ranking, identifying a highest ranked candidate route plan, wherein at least a portion of the highest ranked candidate route plan comprises a route for the UAV; and communicating instructions to the UAV to enable the UAV to navigate the route.

Embodiment 19: The media of embodiment 18, wherein the set of candidate route plans is further determined based on one or more of historical, real-time, or predicted energy consumption information, transporter type information, sender-based preference information, or parcel dimensions and weight.

Embodiment 20: The media of embodiments 18 or 19, wherein the highest ranked candidate route plan comprises a hand off between a manned transporter and the UAV.

It will be understood that certain features and subcombinations are of utility and may be employed without reference to other features and subcombinations and are contemplated within the scope of the claims. Not all steps listed in the various figures need be carried out in the specific order described. Accordingly, the scope of this disclosure is intended to be limited only by the following claims.

What is claimed is:

1. A logistics system for facilitating transport of a parcel, the logistics system comprising:
a plurality of transporters, wherein the plurality of transporters comprises one or more unmanned aerial vehicles (UAVs);
a data collection component that receives navigation data, wherein the navigation data comprises information used to determine a route plan for the transport of parcels;
a candidate route plans engine;
a candidate route plan evaluator;
computer memory storing computer-usable instructions that, when executed by a processor, perform operations comprising:
(i) determining, by the candidate route plans engine, a set of candidate route plans for transporting the parcel from a pickup location to a delivery location, wherein the determining of the set of candidate route plans is based at least on the navigation data, wherein each candidate route plan of the set of candidate route plans is determined by:
identifying one or more available transporters from the plurality of transporters, wherein each of the one or more available transporters has an availability to transport the parcel based at least on the navigation data;
determining a range for each of the one or more available transporters;
based, at least, on the determined range for each of the one or more available transporters, generating a set of potential routes for each of the one or more available transporters; and
assembling at least a subset of the set of potential routes into a candidate route plan for transporting the parcel from the pickup location to the delivery location;
(ii) ranking, by the candidate route plan evaluator, the set of candidate route plans based on a weighted objective, the weighted objective comprising at least one of shipping time or a shipping cost;
(iii) determining the route plan for implementation based on the ranking; and
(iv) communicating the route plan to at least one available transporter associated with the route plan, wherein the at least one available transporter associated with the route plan utilizes the route plan to transport the parcel from the pickup location to the delivery location.

2. The system of claim 1, wherein the navigation data includes one or more of historical, real-time, or predicted weather information, traffic information, transporter location information, or payload and capacity information.

3. The system of claim 1, wherein the weighted objective further comprises transporter energy consumption.

4. The system of claim 3, wherein the weighted objective is determined based on a priority class associated with the parcel.

5. The system of claim 3, wherein the weighted objective is based on a set of tunable weighted goals.

6. The system of claim 1, wherein determining the route plan for implementation further comprises selecting a highest ranked candidate route plan.

7. A computerized logistics system comprising:
one or more sensors configured to determine at least location information for a transporter; and
a logistics server in communication with the one or more sensors, the logistics server having computer memory storing computer-useable instructions that, when executed by a processor, implement a method comprising:
receiving, from the one or more sensors, location information for each transporter of a plurality of transporters, wherein the plurality of transporters comprises at least a manned transporter and an unmanned aerial vehicle (UAV),
determining navigation data based, at least, on the location information, wherein the navigation data comprises information used to determine a route plan for a transport of parcels,
receiving a pickup request that comprises a pickup location and a delivery location of a parcel,
determining a set of candidate route plans for at least one available transporter of the plurality of transporters, wherein the set of candidate route plans is determined based, at least, on the navigation data,
ranking candidate route plans within the set of candidate route plans based on one or more weighted objectives, the one or more weighted objectives comprising at least one of shipping time or shipping cost,
based on the ranking, determining the route plan for implementation from the ranked set of candidate route plans, and
communicating the route plan to the at least one available transporter for navigating the route plan to transport the parcel.

8. The system of claim 7, wherein determining the set of candidate route plans comprises:
determining available transporters from among the plurality of transporters;
determining a range of each of the available transporters;
generating a set of potential routes for each of the available transporters; and
assembling at least a subset of the generated set of potential routes into the set of candidate route plans from the pickup location to the delivery location.

9. The system of claim 7, wherein the navigation data includes one or more of historical, real-time, or predicted weather information, traffic information, transporter location information, or payload and capacity information.

10. The system of claim 7, wherein the one or more weighted objectives further comprise at least one of a number of transporter hand-offs or transporter energy consumption.

11. The system of claim 7, wherein the route plan comprises predicted times and predicted locations for each transporter associated with the route plan.

12. The system of claim 11, further comprising evaluating implementation of the route plan.

13. The system of claim 11, wherein evaluating the implementation of the route plan comprises:
monitoring real-time location information from sensors associated with each transporter associated with the route plan; and
comparing the real-time location information to the predicted times and the predicted locations.

14. The system of claim 13, wherein the real-time location information is different than the predicted times and the predicted locations.

15. The system of claim 14, wherein a new route plan is determined based on a difference between the real-time location information and the predicted times and the predicted locations.

16. The system of claim 14, wherein a new route plan is determined based on an additional pickup request.

17. The system of claim 14, wherein a failsafe procedure is implemented based on a difference between the real-time location information and the predicted times and the predicted locations.

18. One or more computer storage devices storing computer-useable instructions that, when used by one or more computing devices, cause the one or more computing devices to perform a method for determining a route plan that includes an unmanned aerial vehicle (UAV), the method comprising:
receiving location information from one or more sensors associated with a plurality of transporters, the plurality of transporters comprising at least the UAV;
receiving a pickup request for a parcel, the pickup request comprising a pickup location and a delivery location associated with the parcel;
determining that one or more transporters of the plurality of transporters are available for transporting the parcel, the one or more available transporters comprising at least the UAV;
determining a set of candidate route plans for picking up and delivering the parcel, wherein determining the set of candidate route plans is based, at least, on navigation data comprising one or more of historical, real-time, or predicted weather information, traffic information, transported location information, or payload and capacity information;
ranking candidate route plans within the set of candidate route plans based, at least, on a weighted objective, wherein the weighted objective comprises at least one of a shipping time or a shipping cost;
based on the ranking, identifying a highest ranked candidate route plan, wherein at least a portion of the highest ranked candidate route plan comprises a route for the UAV; and
communicating instructions to the UAV to enable the UAV to navigate the route.

19. The media of claim 18, wherein the set of candidate route plans is further determined based on one or more of historical, real-time, or predicted energy consumption information, transporter type information, sender-based preference information, or parcel dimensions and weight.

20. The media of claim 18, wherein the highest ranked candidate route plan comprises a hand off between a manned transporter and the UAV.
